(19) United States
(12) Patent Application Publication
(10) Pub. No.: US 2007/0096359 A1
(43) Pub. Date: May 3, 2007

(54) Method for surface marking a molded article

(76) Inventors: Jan C. Torfs, Terneuzen (NL); David W. Recktenwald, White Lake, MI (US)

Correspondence Address: THE DOW CHEMICAL COMPANY, INTELLECTUAL PROPERTY SECTION,, P. O. BOX 1967, MIDLAND, MI, 48641-1967, US

(21) Appl. No.: 10/562,238

(22) PCT Filed: Jul. 2, 2004
(86) PCT No.: PCT/US04/21508

§ 371 Date: Dec. 22, 2005

(30) Foreign Application Priority Data
Jul. 8, 2003 (US) 60485570

(51) Int. Cl. B29C 33/40; B29C 45/00

(52) U.S. Cl. 264/219; 264/319; 264/328.1

(57) ABSTRACT

The present invention relates to a method to mark the surface of a molded article more specifically to a method to be used as an anti-counterfeit device. The method provides for a molded article with a surface comprising a special mark that is visible under certain conditions and not visible under other conditions.

The present invention relates to a method to mark the surface of a molded article more specifically to a method to be used as an anti-counterfeit device.

In the fight against counterfeiting molded articles, there is ever-increasing pressure to develop security devices which are difficult to forge, that is, replicate. Moreover, it is a requirement that such anti-counterfeiting devices are simple and effective to use without need for additional, often expensive equipment. Preferably, the desired solution would work for molded articles and easily implemented/identifiable around the globe.

The present invention is such an anti-counterfeiting method. In one embodiment the present invention is a method to produce a molded article, preferably a molded thermoplastic article, having a surface with a specific texture which, when viewed under specific conditions, reveals a specific mark. In another embodiment the method of the present invention comprises the steps of providing a mold, preferably an injection mold, with a negative version of a specific texture that is made having a specific topography and molding an article from said mold. In another embodiment of the present invention the negative version of the specific texture of the mold is produced by laser etching. The present anti-counterfeiting method is useful for marking molded articles for such applications as molded articles used in automobiles; home appliances; digital media formats, such as compact disks (CDs) and digital versatile disks (DVDs); and information technology equipment such as housings for cell phones, personal digital assistants (PDAs), and hand held computers.

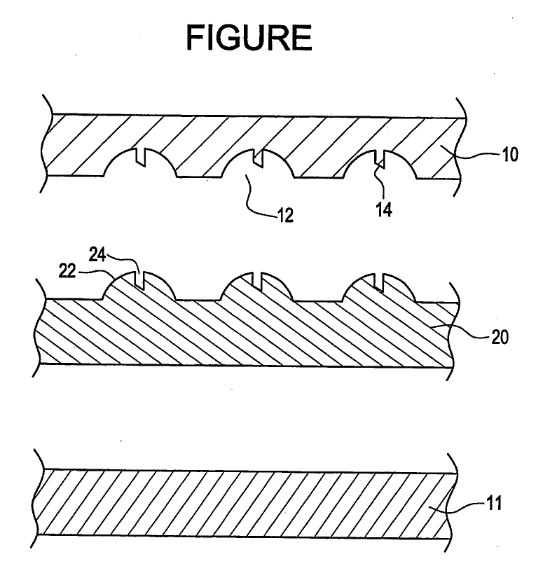

FIG. 1 is a cross sectional view of a portion of a first and second surface of a mold cavity having a negative version of a specific texture on the first surface and a portion of a molded article from said mold having on a first surface the specific texture.

Methods of molding articles are well known and include injection molding, compression molding, vacuum forming, thermoforming, blow molding, rotomolding, and stamping. A preferred molding method for the present invention is injection molding.

The molded material can be any material capable of being molded such as, metals (for example steel, aluminum, magnesium, titanium, or the like); composites; ceramics, plastics or the like. Plastic materials may be thermoset such as a silicone or polyurethane (PU) or preferably thermoplastic. Preferred thermoplastics are polycarbonate (PC); acrylonitrile, butadiene and styrene terpolymer (ABS); polystyrene (PS); polyphenylene oxide (PPO) sometimes referred to as polyphenylene ether (PPE); thermoplastic urethane (TPU); polyvinyl chloride (PVC); acrylic; polyester (PES) such as polybutylene terephthalate (PBT) and polyethylene terephthalate (PET); polyolefin (PO) such as polyethylene (PE), polypropylene (PP), thermoplastic polyolefin (TPO), and polyamide (PA); and blends thereof such as PC/PS; PC/ABS; PS/PPO or PS/PPE; PC/PES; PPO/PES or PPE/PES; and PC/PO.

The molded article of the present invention has at least two surfaces. A surface appearance, such as but not limited to a texture, is selected which will be the basis of the appearance on the molded article. Preferably, part or all of one or more of the surfaces of the molded article of the present invention is textured. Methods to characterize the surface appearance of an object and reproduce said appearance on another object are well known, see US Patent Publication No. 2002-0118357 and U.S. patent application Ser. No. 60/387,778. Further, methods for providing texture to a surface of a mold are well known and will not be described herein, see for example EP 167075 and WO 01/73372. A negative version (sometimes referred to as reverse or mirror image) of the texture comprises part or all of at least one surface of the mold which defines the mold cavity from which the molded article is produced. Texture is used herein to describe any surface appearance on the molded article, such as a pattern, structure, scheme, etc. The present invention requires the mold surface comprising the negative version of the texture further comprise a negative version of a specific texture preferably surrounded by and/or adjacent to the negative version of the texture. Material is placed in said mold and molded to provide an article having a first surface with a positive version of the specific texture referred to as a specific mark (sometimes referred to as a watermark). The specific mark may appear as one or more logo, letter, word, number, graphical representation, symbol, or combinations thereof. The negative version of the specific texture is formed by etching the negative version of the texture on a first surface of the mold. Etching can be done by acid etching and electronic discharge machining (EDM), preferably by laser etching. Etching, specifically laser etching is well known in the art and will not be described herein.

The negative version of the specific texture may be etched into the mold surface itself or etched into a mold insert which can be inserted into the mold to form part of the surface of the mold cavity. Molded articles having different specific marks may be produced by the same mold by using mold inserts having different negative versions of specific textures. For example, a first molded article with a first specific texture may be molded in a mold with a mold insert having a first negative version of a first specific texture. A second molded article with a second specific texture can be molded in the same mold if a second mold insert having a second negative version of a second specific texture is inserted into the mold. A third molded article with a third specific texture can be molded in the same mold if a third mold insert having a third negative version of a third specific texture is inserted into the mold. This process can be repeated for as many mold inserts/negative versions of specific textures as desired. Mold inserts provide a way to supply one or more negative versions of specific textures to one or more molds, which may be located at one or more locations around the globe. Mold inserts provide an easy and economical method to provide one or more mold for providing molded articles having a surface with the same or different specific mark. It further provides an easy and economical method to provide a different (that is, second, third, forth, etc.) negative version of a specific texture for a certain molded article. Ease of changing mold inserts with different negative versions of specific textures complicates counterfeiting the molded article because the specific mark on its surface can be changed quickly and cost effectively with little effort.

In one embodiment, the specific mark on the surface of the molded article is visible at certain viewing angles and invisible at other angles. For example, the angle may be such that when viewed from a first predetermined angle, for instance straight on, the specific mark is not visible, but when viewed from a second angle, other than the predetermined angle, the specific mark is visible. In another embodiment, the specific mark on the surface of the molded article is visible under a first lighting condition and not visible under a second lighting condition. In yet another embodiment of the present invention, the specific mark on the surface of the molded article is not visible when viewed under certain lighting conditions from a first predetermined angle, but when viewed under said lighting conditions from a second angle, other than the predetermined angle, the specific mark is visible.

Any means to provide the specific topography of the negative version of the specific texture is within the scope of this invention. By way of example, without limitation, a specific topography of the negative version of the specific texture is shown in FIG. 1. The negative version of the specific texture is etched in a first surface of the mold 10 and comprises a plurality of indentations, such as a crater 12, comprising a smaller protrusion, such as a pillar 14. In the molded article, the positive version of the specific texture, or specific mark, appear as a plurality of protrusions, such as a bump 22, with small indentation, such as a hole 24, on its surface 20. The small holes reflect light differently making the specific mark more or less visible when viewed under specific conditions, for example, at certain (different) angles, preferably only visible when viewed at a predetermined angle. The negative version of the specific texture comprises a plurality of indentations and protrusions. Each indentation/protrusion making up the negative version of the specific texture may be the same or different depending on the desired appearance of the specific mark on the surface of the molded article.

The negative version of the specific texture may be created in other ways by modifying the properties of the negative version of the texture within a defined shape by angularly offsetting the negative version of the specific texture such that it has a different direction than the negative version of the texture. This includes, for example, shifting, rotating, or inverting the negative version of the texture such that the negative version of the specific texture has a different direction than the negative version of the texture. Alternatively, the negative version of the specific texture may be created by modifying the properties of the negative version of the texture within a defined shape instead of or in combination with offsetting its direction. For example the negative version of the specific texture can be reduced or enlarged. Alternatively, the negative version of the specific texture may be etched deeper or shallower than the negative version of the texture. Thus the negative version of the specific texture is produced with a different texture depth than the surrounding negative version of texture. The negative version of the specific texture can also be a different texture grain than that of the negative version of the texture.

The article having a molded surface with the specific mark visible under certain conditions may be molded from pre-colored material and/or the surface of the article may be painted and/or the surface may have an overlay, for instance fabric or leather, and/or decorated in other fashions as long as the specific mark is visible under some conditions, such as viewing angles, light, etc., and not visible under other conditions.

Although the present invention has been described in detail in connection with the discussed embodiments, various modifications may be made by one of ordinary skill in the art without departing from the spirit and scope of the present invention. For example, while the method of the present invention is preferably an anti-counterfeiting method, it could presumably be used for other purposes such as providing a decorative effect in a molded article or an aesthetically pleasing appearance in a molded article, etc. Therefore, the scope of the present invention should be determined by the attached claims.

What is claimed:

1. A method for the manufacture of a molded article having a specific mark on the surface thereof, comprising the steps of:
(i) providing a mold having a surface defining a mold cavity, said surface including a negative version of a texture and a negative version of a specific texture,
(ii) placing a material into said mold cavity,
(iii) molding said material to define an article, said article including a specific mark on its surface which is a positive version of the negative version of the specific texture,
wherein the specific mark is visible under certain conditions and not visible under other conditions.

2. The method of claim 1 wherein the specific mark is visible at a predetermined viewing angle and not visible at other viewing angles.

3. The method of claim 1 wherein the specific mark is visible under a first lighting condition and not visible under a second lighting condition.

4. The method of claim 1 wherein the negative version of the specific texture is laser etched into the mold surface.

5. The method of claim 1 wherein the negative version of the specific texture comprises a plurality of indentations, each indentation comprising a protrusion.

6. The method of claim 1 wherein the negative version of the specific texture is achieved by angularly offsetting the negative version of the texture.

7. The method of claim 1 wherein the negative version of the specific texture is achieved by changing the size of the negative version of the texture.

8. The method of claim 1 wherein the negative version of the specific texture is achieved by changing the depth of the negative version of the texture.

9. The method of claim 1 wherein the negative version of the specific texture is contained on a mold insert which, when inserted into the mold, is part of the surface that defines the mold cavity.

10. The method of claim 1 wherein the mold is an injection mold and the molded article is injection molded.

11. The method of claim 1 wherein the material is a metal, a composite, a ceramic, a thermoset, a thermoplastic or combination thereof.

12. The method of claim 1 wherein the material a thermoplastic.

13. The method of claim 12 wherein the thermoplastic is polycarbonate (PC), acrylonitrile, butadiene and styrene terpolymer (ABS), polystyrene (PS), polyphenylene oxide (PPO), polyphenylene ether (PPE), thermoplastic urethane (TPU), polyvinyl chloride (PVC), acrylic, polyester (PES), polyolefin (PO), thermoplastic polyolefin (TPO), polyamide (PA), or blends thereof.

14. A molded article produced by the method of claim 1.
